(19) United States
(12) Patent Application Publication
(10) Pub. No.: US 2021/0039340 A1
(43) Pub. Date: Feb. 11, 2021

(54) Method and Apparatus for Injecting Sealant Directly Into Tire Punctures

(71) Applicant: Bret Edward Cahill, Brawley, CA (US)

(72) Inventor: Bret Edward Cahill, Brawley, CA (US)

(21) Appl. No.: 16/536,313

(22) Filed: Aug. 9, 2019

(51) Int. Cl. B29C 73/02

(52) U.S. Cl. CPC B29C 73/025

(57) ABSTRACT

A small amount of high viscosity sealant is injected under high pressure into pneumatic tire punctures. By eliminating the steps of wheel, tire and tube removal and reassembly, air leakage is permanently blocked in seconds reducing down time by two orders of magnitude.

### CROSS-REFERENCE TO RELATED APPLICATION

Not applicable

### BACKGROUND-DESCRIPTION OF PRIOR ART

Bicycles and e-bikes offer some of the best opportunities to reduce CO2 emissions and congestion as well as improving public health and quality of life. The thin light weight tires, however, are prone to getting punctured. The time wasted repairing flats on the side of the road is discouraging to many other wise avid cyclists. Repairing flats near traffic is the chief drawback to an otherwise highly reliable form of transportation. Many quit cycling altogether.

All the preventative solutions to date such as adding liquid sealants, thorn proofing tires or aftermarket strips all result in increasing the mass of the wheel near the rim thereby increasing the moment of inertia of the wheel set. Not only must the rider overcome the translational momentum of the additional weight, the angular momentum must be overcome as well. This results in poor performance accelerating through intersections or knee injuries.

Most common sealants also dry out after a few months requiring that they be scraped out or more rotational weight added to the tire. Moreover, when the bike is parked overnight with an undetected puncture at top dead center, liquid sealants leak away and the tire must be pumped up again in the morning. Finally, liquid sealants are generally messy.

The traditional solution of carrying a spare replacement inner tube and replacing it on the side of the road is hazardous near heavy traffic, unpleasant in inclement conditions and an inconvenience without a full tool set and work stand. Vulcanizing patches are unreliable and always require removing the wheel, tire and inner tube then reassembly and re-inflation.

### SUMMARY

Injecting high viscosity sealant under high pressure directly into the puncture quickly permanently seals the puncture eliminating the above issues.

### Advantages

By injecting sealant directly into punctures, leaks can be repaired in seconds even before the tire loses much pressure allowing for low maintenance low rotational weight wheel sets. Less skill is required than with vulcanizing patches to reliably stop leaks.

### DESCRIPTION OF THE DRAWING

FIG. 1 Cross Section of Punctured Tire and Injector

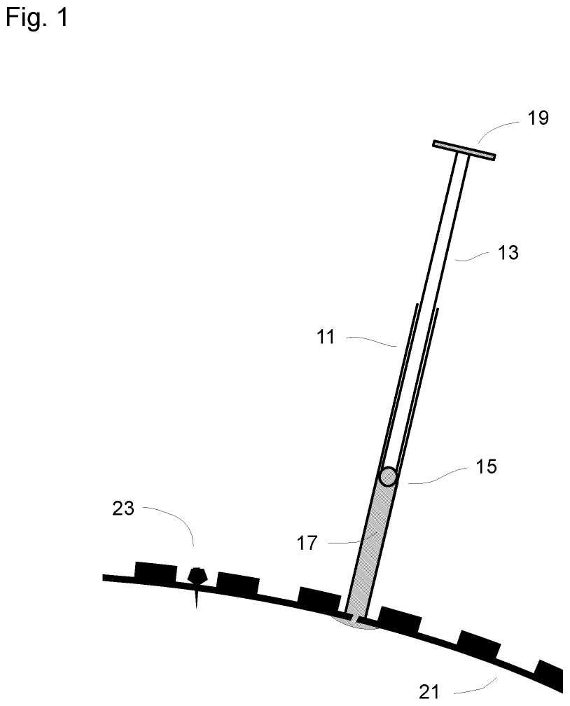

### REFERENCE NUMBERS TO THE DRAWING

11 narrow bore cylinder
13 piston rod
15 spherical piston head
17 high viscosity sealant
19 thumb plate
21 inside of tire
23 typical puncturing object

### DETAILED DESCRIPTION

From hydraulics the pressure in a cylinder is the force on the piston divided by the cross sectional area of the cylinder. If the piston-cylinder arrangement has a small enough cross sectional area, a relatively small force on the piston will result in a large pressure, enough to overcome the viscous forces of the sealant as well as the pressure inside of the vehicle tire. Since most punctures are very small in diameter the puncture can be sealed with just a few micro liters of sealant. One small light weight tube weighing a few grams can easily repair multiple punctures.

### Method

When the cyclist first becomes aware that the tire is punctured, either by loss of air pressure or directly observing the puncturing object, he stops, rotates the wheel until the puncture is accessible. The injector is pressed against the rubber surrounding the puncture with enough force to create a seal between the tire and the injector. The sealant is then pumped into the tire and inner tube. If the puncturing object didn't completely penetrate the tire, the sealant will not flow into the tire and is indicated by a high resistance to flow in the injector.

I claim:

1. An apparatus with a means of developing pressure to force sealant from a vessel for injection of said sealant directly into a puncture on a pneumatic tire.

2. The apparatus in claim 1 where said vessel is a hollow cylinder and said pressure is developed by a piston moving in said cylinder.

3. The apparatus in claim 2 where said hollow cylinder contains said sealant.

4. The apparatus in claim 3 where said cylinder has a narrow bore to develop high pressure to force high viscosity sealant through said cylinder into said puncture.

5. The apparatus in claim 1 where said sealant is elastomeric and cures.

6. The apparatus in claim 1 where said sealant remains a viscous liquid for a long time.

7. The apparatus in claim 1 where said vessel is made of a material that can be heated to lower the viscosity of said sealant.
